(19) United States
(12) Patent Application Publication
(10) Pub. No.: US 2010/0294002 A1
(43) Pub. Date: Nov. 25, 2010

(54) OPTICAL FIBER PREFORM MANUFACTURING METHOD

(75) Inventors: Masahide ITO, Tokyo (JP); Jun TERADA, Tokyo (JP); Shinji YOKOYAMA, Tokyo (JP); Mitsuhiro KAWASAKI, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: FURUKAWA ELECTRIC CO., LTD., Tokyo (JP)

(21) Appl. No.: 12/780,347

(22) Filed: May 14, 2010

(30) Foreign Application Priority Data
May 19, 2009 (JP) 2009-120731

(51) Int. Cl. C03B 37/01

(52) U.S. Cl. 65/426

(57) ABSTRACT

The present invention provides a method for manufacturing an optical fiber preform, which provides an optical fiber with stable transmission loss characteristics, and improves manufacturing efficiency. The method for manufacturing an optical fiber preform comprises dehydrating the optical fiber soot preform by lowering the optical fiber soot preform within the muffle tube and passing through a heating region, pulling up the dehydrated optical fiber soot preform to the predetermined position, and sintering the optical fiber soot preform by lowering the optical fiber soot preform again within the muffle tube and passing through the heating region where temperature of the heating region is higher than temperature of the heating region in dehydrating; wherein A≦B is satisfied where A is pull-up speed (mm/minute) of the optical fiber soot preform during the pulling up and B is gas flow rate (mm/minute) within the muffle tube at room temperature during the pulling up. Furthermore, 1.5×A≦B is satisfied.

### CROSS-REFERENCE TO RELATED APPLICATIONS

This application claims the benefit of priority from Japanese Patent Application No. 2009-120731 filed May 19, 2009, the entire contents of which is incorporated herein by reference.

### TECHNICAL FIELD

The present invention relates to optical fiber preform manufacturing method. More particularly, the invention relates to dehydration and sintering of an optical fiber soot preform including a core.

### BACKGROUND OF THE INVENTION

Conventionally, dehydrating and sintering of an optical fiber soot preform is carried out using a dehydrating-sintering device. The dehydration-sintering device is equipped with a muffle tube and a heater. The muffle tube is capable of holding an optical fiber soot preform supported by a supporting rod, and the heater is positioned around the circumference of the muffle tube. A gas supply port is positioned at the bottom portion of the muffle tube and the gas supply port supplies gases (such as inert gases) needed to dehydrate and sinter the optical fiber soot preform. In addition, a gas exhaust pipe is positioned at the top portion of the muffle tube, and the gas exhaust pipe discharges the gases supplied from the gas supply port. Furthermore, the optical fiber soot preform supported by the supporting rod is dehydrated and sintered by lowering the optical fiber soot preform while rotating it within the muffle tube and passing it through a heating region by the heater.

A two-stage vitrification is commonly used as a dehydration and sintering method. In the method, an optical fiber soot preform is dehydrated by passing through a heating region, which temperature is set between 900° C.-1300° C., then the dehydrated optical fiber soot preform is pulled up to a predetermined position along the muffle tube and sintered by passing through the heating region again, which temperature is set between 1400° C. and 1600° C.

However, if pressure within the muffle tube becomes negative, an ambient air may enter in the muffle tube and impurities contaminate in the optical fiber soot preform; and transmission loss of the resulting optical fiber may increase. Therefore, the pressure is controlled such that the internal pressure of the muffle tube is higher than outside by a predetermined value (usually around several tens of Pascal) in the dehydration-sintering process.

Furthermore, pressure fluctuation within the muffle tube is known to be significant if the ratio between the outer diameter of the optical fiber soot preform and the inner diameter of the muffle tube is small, and/or the optical fiber soot preform moves vertically within the muffle tube. Japanese Patent Application Laid-open Hei 08-157229 discloses a method to prevents differential pressure fluctuations within a muffle tube, entry of an ambient air and leakage of gases in the muffle tube during dehydration and sintering of an optical fiber preform by making the ratio between the outer diameter of the optical fiber soot preform and the inner diameter of the muffle tube to be more than 1.5.

Recently, size of the optical fiber preform is increased to reduce manufacturing cost. However, the inner diameter of the muffle tube needs to be significantly large in order to prevent differential pressure fluctuations within the muffle tube according to the above method, which requires the ratio between the outer diameter of the optical fiber soot preform and the inner diameter of the muffle tube to be more than 1.5. Also, in the above method, size of the manufacturable preforms are limited by the ratio between the outer diameter of the optical fiber soot preform and the inner diameter of the muffle tube; and only relatively small optical fiber preforms with respect to the amount of the supplied gas can be made. Therefore, there is an issue of manufacturing inefficiency with this method.

### BRIEF SUMMARY OF THE INVENTION

The present invention discloses a method for manufacturing an optical fiber preform, which is not affected by the ratio between the outer diameter of the optical fiber soot preform and the inner diameter of the muffle tube, provides an optical fiber with stable transmission loss characteristics, and improves manufacturing efficiency.

To achieve the above purpose, the method for manufacturing an optical fiber preform, comprises dehydration of the optical fiber soot preform by lowering the optical fiber soot preform within a muffle tube and passing through a heating region, pull-up the dehydrated optical fiber soot preform to the predetermined position and sintering the dehydrated optical fiber soot preform by lowering the optical fiber soot preform again within the muffle tube and passing through the heating region where temperature of the heating region is higher than temperature of the heating region in dehydrating. During the dehydration, pull-up, and sintering; gases are supplied to the muffle tube from bottom, and A≦B is satisfied where A is pull-up speed (mm/minute) of the dehydrated optical fiber soot preform during the pulling up and B is gas flow rate (mm/minute) within the muffle tube at room temperature during the pulling up.

### BRIEF DESCRIPTION OF THE DRAWINGS

FIG. 1 shows a dehydration-sintering device, which is related to an embodiment of the present invention; and

FIG. 2 shows relationship between pull-up speed A (in mm/minute) and gas flow rate B (in mm/minute) for examples relates to embodiments of the present invention and comparative examples.

### DETAILED DESCRIPTION

Below, an optical fiber preform manufacturing method relates to embodiments of the present invention is explained.

### Embodiments of the Present Invention

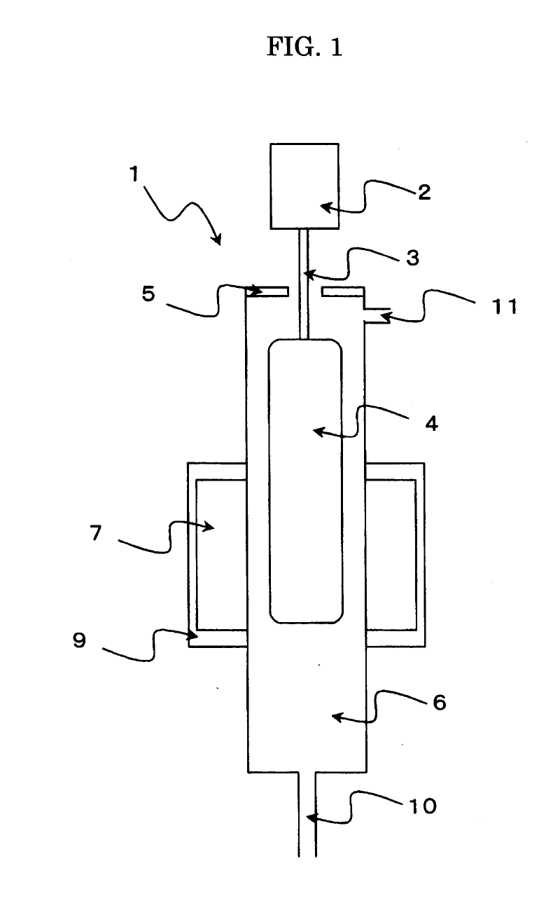

First, a dehydration-sintering device and an optical fiber soot preform used in the embodiments are explained. FIG. 1 shows a cross-sectional schematic view of the dehydration-sintering device and the optical fiber soot preform 4 used in the embodiments.

The dehydration-sintering device 1 has a muffle tube 6, a heater 7 around the circumference of the muffle tube 6 and a furnace body 9 around the circumference of the muffle tube 6. The muffle tube 6 is made from silica glass and has a top cover 5 to contain the optical fiber soot preform 4, which is connected to a rotating-lifting device 2 through a supporting rod 3. The heater 7 heats the optical fiber soot preform 4 from outside. The furnace body 9 contains the heater 7 through a heat-insulating material.

Also, the muffle tube 6 has a gas supply port 10 at its bottom portion and a gas exhaust 11 at its top portion. The gas supply port 10 supplies gases needed for dehydration and sintering to the muffle tube 6. The gases include inert gases such as helium gas. The gas exhaust 11 discharges the gases in the muffle tube 6 to the outside of the muffle tube 6.

The optical fiber soot preform 4 is synthesized, for example, by Vapor phase Axial Deposition (VAD) method and has a core portion created around the central axis and a cladding portion at the circumference of the core portion. A glass rod made from dehydration and sintering of an optical fiber soot preform 4 including a core portion is called a core rod.

Next, a core rod manufacturing method from dehydration and sintering of an optical fiber soot preform 4 including a core portion is explained in detail. In the method, the dehydration-sintering device 1 shown in FIG. 1 is used. The core rod manufacturing method relates to the optical fiber preform manufacturing method of the present invention, and includes three processes: dehydration process, switch process and sintering process. First, dehydration process is explained.

### (Dehydration Process)

The supporting rod 3 is held by the holding portion of the rotating-lifting device 2 and one end of the supporting rod 3 is connected to top of the optical fiber soot preform 4. Then, the optical fiber soot preform 4 is inserted to muffle tube 6 and covered by a top cover 5. Next, the optical fiber soot preform 4 is set to a predetermined starting position, and the heater 7 is heated to a predetermined temperature.

The temperature of the heater 7 is controlled such that the highest temperature inside of the muffle tube 6 becomes a predetermined processing temperature. The processing temperature is commonly between 900° C. and 1300° C.

The gas supply port 10 supplies gases needed for dehydration to the muffle tube 6. The gases include helium gas and chlorine gas. Then, the optical fiber soot preform 4 is rotated and lowered by the rotating-lifting device 2 at a predetermined speed. The dehydration process described above is conventional process.

### (Switch Process)

Next, switch process is explained. When the top edge of the optical fiber soot preform 4 is sufficiently heated by the heating region, the optical fiber soot preform 4 is returned to approximately the same height as the starting position by the rotating-lifting device 2. At the time, the temperature of the heater 7 is approximately the same temperature as in the dehydration process and the gas supply port 10 supplies gases such as helium gas to the muffle tube 6. Also at the time, A and B is controlled to satisfy A≦B wherein A is pull-up speed of the optical fiber soot preform 4 in mm/minute and B is gas flow rate within the muffle tube 6 at room temperature in mm/minute. By doing so, transmission loss characteristics of the resulting optical fiber can be stabilized. Preferably, A and B is controlled to satisfy 1.5×A≦B. By doing so, transmission loss characteristics of the resulting optical fiber can be further stabilized.

Gas flow rate B within the muffle tube 6 is calculated as follows:

Gas low rate B(mm/minute)=(Gas flow supplied to the muffle tube (L/minute)×1000)/Cross sectional area of the muffle tube 6(cm²)×10

As described above, the gas flow rate B within the muffle tube 6 adapts gas flow rate at room temperature. The temperature within the muffle tube 6 ranges from several hundred to 1300° C. during the actual switch process. In such high temperature, gases within the muffle tube 6 become complex turbulent flow due to the effect of gas expansion and contraction. Because it is difficult to examine actual gas flow rate, gas flow rate at room temperature is adapted.

In the present invention, room temperature gas flow rate B within the muffle tube 6 is adapted as one parameter, and the relationship between the gas flow rate B and the transmission loss characteristics of the resulting optical fiber is considered.

### (Sintering Process)

Next, sintering process is explained. The temperature of the heater 7 is controlled such that the highest temperature inside of the muffle tube 6 becomes a predetermined processing temperature. The processing temperature is commonly between 1400° C. and 1600° C. Then, the gas supply port 10 supplies gases needed such as helium gas for sintering to the muffle tube 6.

Afterward, the optical fiber soot preform 4 is rotated and lowered by the rotating-lifting device 2 at a predetermined speed and sintered from the bottom by passing through the heating region. The sintering process described above is conventional process. Because of the sintering process, the optical fiber soot preform 4 becomes a transparent glass, and therefore, it becomes a transparent core rod.

A cladding is added to the resulting core rod by known methods such as Outside Vapor Deposition (OVD) and/or Rod In Tube (RIT) to obtain a glass optical fiber preform with a predetermined core and cladding ratio. Then, optical fiber can be obtained by drawing the glass optical fiber preform using a known method.

Until now, when two-stage vitrification, which dehydrates the optical fiber soot preform 4 by lowering through the heating region, pulls up the dehydrated optical fiber soot preform 4 and sinters the preform by lowering through the heating region again is done, the pull-up operation of the dehydrated optical fiber soot preform 4 between the dehydration process and the sintering process is simply a operation to move the optical fiber soot preform 4 for the sintering process, and the preform is moved at relatively high speed to reduce manufacturing time.

However, the inventors of the present invention found that optical fiber transmission loss is affected by the pull-up of operation of the optical fiber soot preform 4 between the dehydration process and the sintering process.

With the optical fiber manufacturing method of the present invention, an optical fiber with stable transmission loss characteristics can be obtained even if the ratio of the outer diameter of the optical fiber soot preform and the inner diameter of the muffle tube is small.

Also, Helium commonly used as an inert gas supplied to the dehydration-sintering device is very expensive. Therefore, it is preferred to dehydrate and sinter with minimum supplied gas possible to reduce manufacturing cost. However, if supplied gas is reduced, it is difficult to keep positive pressure within the muffle tube and the stability of the transmission loss characteristics of the resulting optical fiber tends to reduce. However, if the optical fiber manufacturing method of the present invention is used, optical fiber with stable transmission loss characteristics can be manufactured even when relatively low gas is supplied during dehydration and sintering processes.

### EXAMPLE 1 AND COMPARATIVE EXAMPLE 1

Below, example 1 of the present invention and comparative example 1 are explained in detail.

An optical fiber soot preform 4 is dehydrated and sintered using a dehydration-sintering device 1 with a muffle tube 6 having an inner diameter of 200 mm. The optical fiber soot preform 4 includes a core and a cladding manufactured by VAD. The optical fiber soot preform 4 has a maximum outer diameter (thereafter, outer diameter) of 150-170 mm before dehydration process and a length of 1000 mm. Therefore, the ratio between the inner diameter of the muffle tube 6 and the outer diameter of the optical fiber soot preform 4 is approximately 1.15 to 1.30.

A core rod is manufactured from the optical fiber soot preform 4 through dehydration, switch, and sintering processes described above. By changing pull-up speed A (mm/minute) and gas flow rate B (mm/minute), 20 core rods are manufactured with each condition, where A is one of the manufacturing parameters during the switch process and B adapted gas flow rate flow within the muffle tube 6 at room temperature.

The resulting core rods are further processed with OVD to add more cladding to make glass optical fiber preforms. Once predetermined core/cladding ratio is obtained, the glass optical fiber preforms are drawn with a known method to obtain optical fibers. The manufactured optical fibers are conventional single-mode optical fibers, which have zero-dispersion wavelength at around 1.3 μm.

Longitudinal transmission loss fluctuations of the optical fibers are measured to compare stability of the resulting optical fibers' transmission loss characteristics. As a measurement method, an optical fiber (approximately 1000 km) from one optical fiber soot preform 4 is cut every 50 km and transmission loss of each sample is measured by optical fiber analysis system for spectral attenuation. Transmission losses at 1.31 μm is measured for optical fibers obtained from each optical fiber soot preform 4, then the difference between the samples with maximum transmission loss and minimum loss (thereafter, longitudinal transmission loss fluctuations) is evaluated.

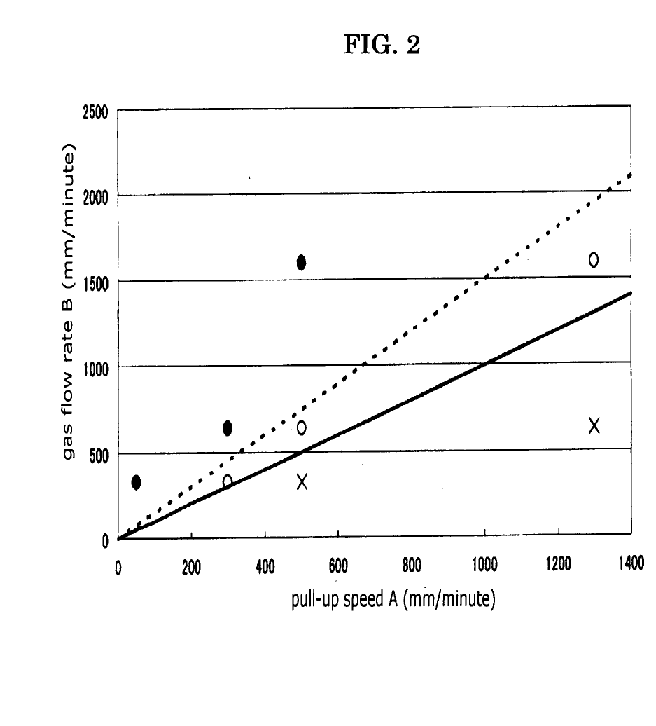

The table 1 shows results obtained from the above evaluation. Also, FIG. 2 shows relationship among pull-up speed A (mm/minute), gas flow rate B (mm/minute) and transmission loss of the resulting optical fibers for each conditions tested.

In table 1 and FIG. 2, pass or fail of a sample is decided in the following manner. In FIG. 2, ⊚ is shown as .

⊚ (also ); manufacturing condition, which longitudinal transmission loss fluctuations are within 0.005 dB/km for optical fibers obtained from all 20 core rods.

◯; manufacturing condition, which longitudinal transmission loss fluctuations are over 0.005 dB/km for optical fibers obtained from five core rods or less and it is within acceptable level.

×; manufacturing condition, which longitudinal transmission loss fluctuations are over 0.005 dB/km for optical fibers obtained from five core rods or more.

Above evaluation standard is based on longitudinal transmission loss fluctuations of 0.005 dB/km. The reason of the base is that the difference is considered as a significant when measurement error at 1.31 μm of the optical fiber analysis system for spectral attenuation is considered.

TABLE 1

| | Pull-up | Gas | Gas flow | Longitudinal |
|---|---|---|---|---|
| | speed A | flow | rate B | transmission loss |
| | (mm/minute) | (L/minute) | (mm/minute) | fluctuation band |
| Condition 1 | 1300 | 50 | 1592 | ◯ |
| Condition 2 | 1300 | 20 | 637 | X |
| Condition 3 | 500 | 50 | 1592 | ⊚ |
| Condition 4 | 500 | 20 | 637 | ◯ |
| Condition 5 | 500 | 10 | 318 | X |
| Condition 6 | 300 | 10 | 318 | ◯ |
| Condition 7 | 300 | 20 | 637 | ⊚ |
| Condition 8 | 50 | 10 | 318 | ⊚ |

Broken line on FIG. 2 shows manufacturing condition where 1.5×A=B, and conditions 3, 7 and 8 are positioned above the broken line (i.e.1.5×A≦B). All of the optical fibers obtained from the core rods manufactured under the conditions in this area have longitudinal transmission loss fluctuations within 0.005 dB/km and the transmission loss characteristics are stable. Solid line shows manufacturing condition where A=B and conditions 1, 4 and 6 are located between the solid line and broken line and five or less of the 20 core rods have longitudinal transmission loss fluctuations of 0.005 dB/km or more. Also, conditions 2 and 5 are in A>B area, and more than five of the 20 core rods have longitudinal transmission loss fluctuations of 0.005 dB/km or more and lack stability in transmission loss characteristics.

Almost all of the samples manufactured with conditions 2 and 5, which create longitudinal transmission loss fluctuations of 0.005 dB/km or more have large transmission loss in optical fibers, which are manufactured from the top edge side of the dehydration-sintering device 1 during dehydration and sintering processes; and it is expected that the resulting optical fibers are affected by the ambient air enters from the top cover 5 of the dehydration-sintering device 1.

In the above examples, the cases where a ratio between the inner diameter of the muffle tube 6 and the outer diameter of the optical fiber soot preform 4 is approximately 1.15 to 1.30 are researched. However, as the ratio between the inner diameter of the muffle tube 6 and the outer diameter of the optical fiber soot preform 4 becomes larger, ambient air is difficult to get into the muffle tube 6. For the reason, if optical fiber manufacturing method of the present invention is used, an optical fiber with low transmission loss fluctuation in the longitudinal direction muffle tube can be obtained without depending on the ratio between the inner diameter of the muffle tube and the outer diameter of the optical fiber soot preform.

Larger B with respect to A makes transmission loss fluctuation in the longitudinal direction lower. However, if pull-up speed A of the optical fiber soot preform 4 is too slow (for example 30 mm/minute or less)or gas flow rate B (mm/minute) is too fast (for example 1500 mm/minute or more), then manufacturing cost increases significantly. Therefore, 2.0×A≧B is preferable. Also, to keep stable positive pressure within the muffle tube 6, gas flow rate B is preferred to be 50 mm/minute or more.

### EXAMPLE 2

In example 1 and comparative example 1, gas flow rate supplied in the muffle tube during the dehydration and sintering processes is not specified; however, commonly the amount of gas supplied in the muffle tube during the switch process is approximately the same as the amount supplied during the dehydration and sintering processes.

However, if gas flow supplied to the muffle tube during the dehydration and sintering processes is low, the optical fiber soot preform needs to be pulled up at significantly low speed to satisfy A≦B and it leads to manufacturing inefficiency, where A is pull-up speed (in mm/minute) of the optical fiber soot preform during the switch process and B is gas flow rate (in mm/minute) flown within the muffle tube at room temperature.

In this example, C>D is satisfied where C is gas flow (in L/minute) supplied to the muffle tube during the switch process, and D is gas flow (in L/minute) supplied to the muffle tube during the dehydration process. In other words, gas flow supplied to the muffle tube during the dehydration process is larger than gas flow supplied to the muffle tube during the switch process.

By doing so, A≦B can be satisfied even if pull-up speed of the optical fiber soot preform during the switch process is fast.

Gas flow supplied to the muffle tube during the dehydration process is set to 30 L/minute, and gas flow supplied to the muffle tube during the switch process is set to 50 L/minute. By doing so, even if pull-up speed (in mm/minute) of the optical fiber soot preform is 1300 mm/minute; an optical fiber, which has the same transmission loss with condition 1 on table 1 (five or less of the 20 core rods have longitudinal transmission loss fluctuations of 0.005 dB/km or more) can be obtained. Also, if gas flow supplied to the muffle tube during the dehydration process is set to 30 L/minute, gas flow supplied to the muffle tube during the switch process is set to 50 L/minute and pull-up speed of the optical fiber soot preform is 500 mm/minute; optical fiber, which has the same transmission loss with condition 3 on table 1 (all 20 core rods have longitudinal transmission loss fluctuations of 0.005 dB/km or less) can be obtained. Also, gas flow supplied to the muffle tube during the sintering process is selected arbitrarily and, for example, it can be approximately the same amount with the dehydration process.

What is claimed is:

1. A method for manufacturing an optical fiber preform, comprising:
dehydrating the optical fiber soot preform by lowering the optical fiber soot preform within a muffle tube and passing through a heating region;
pulling up the dehydrated optical fiber soot preform to the predetermined position; and
sintering the dehydrated optical fiber soot preform by lowering the optical fiber soot preform again within the muffle tube and passing through the heating region where temperature of the heating region is higher than temperature of the heating region in dehydrating
wherein during dehydrating, pulling up, and sintering, gases are supplied to the muffle tube from bottom, and
A≦B is satisfied where A is pull-up speed (mm/minute) of the dehydrated optical fiber soot preform during the pulling up and B is gas flow rate (mm/minute) within the muffle tube at room temperature during the pulling up.

2. The method of claim 1, wherein 1.5×A≦B is satisfied where A is pull-up speed (mm/minute) of the dehydrated optical fiber soot preform during the pulling up and B is gas flow rate (mm/minute) within the muffle tube at room temperature during the pulling up.

3. The method of claim 1, wherein C>D is satisfied where C is a volume of gas flow (L/minute) supplied to the muffle tube during the pulling up, and D is the volume of gas flow (L/minute) supplied to the muffle tube during the dehydrating.
